(19) United States
(12) Patent Application Publication
(10) Pub. No.: US 2006/0090625 A1
(43) Pub. Date: May 4, 2006

(54) Band saw

(75) Inventor: Fu-Seng Wang, Taichung County (TW)

Correspondence Address: BACON & THOMAS, PLLC, 625 SLATERS LANE, FOURTH FLOOR, ALEXANDRIA, VA, 22314, US

(73) Assignee: OAV EQUIPMENT & TOOLS, INC., TAICHUNG HSIEN (TW)

(21) Appl. No.: 10/974,818

(22) Filed: Oct. 28, 2004

(51) Int. Cl. B26D 1/46

(52) U.S. Cl. 83/788; 83/801; 83/810

(57) ABSTRACT

A band saw includes a saw base having an upright support, a worktable supported on the upright support and tiltable relative to the saw base, and an adjustment mechanism for driving the worktable to tilt relative to the saw base. The adjustment mechanism includes a locating seat fastened to the saw base and provided with a guiding channel, and a movable bar slidably inserted through the guiding channel of the locating seat. The movable bar has an end slidably coupled to the worktable. A driving unit is connected to the movable bar for driving the movable bar to move axially.

### BACKGROUND OF THE INVENTION

1. Field of the Invention

The present invention relates generally to a sawing machine and more particularly, to a band saw, which has means for enabling the user to adjust the tilt angle of the worktable conveniently.

2. Description of the Related Art

In order for cutting the workpiece at different angles, a band saw has the worktable designed to be angularly adjustable. FIG. 5 shows the worktable tilt angle adjustment mechanism of a band saw according to the prior art. As illustrated, the band saw 90 comprises a saw base 92, a worktable 94 provided above the saw base 92, and a positioning plate 96 connected below the worktable 94. The positioning plate 96 has an arched sliding slot 100 and an arched guide slot 98 having a toothed portion 982 disposed along one side thereof. A screw bolt 102 is inserted through the arched sliding slot 100 and threaded into the saw base 92 such that the positioning plate 96 is tiltable relative to the saw base 92 when the screw bolt 102 is loosened, and the positioning plate 96 is affixed to the saw base 92 when the screw bolt 102 is fastened tight. A guide screw rod 104 is inserted through the saw base 92 and the arched guide slot 98. A gear 106 is fixedly sleeved onto the guide screw rod 104 and meshed with the toothed portion 982. A knob 108 is fixedly connected to one end of the guide screw rod 104. When the user rotates the knob 108, the screw rod 104 will be rotated, thereby causing the positioning plate 96 to be tilted relative to the saw base 92 by the match of the gear 106 to the toothed portion 982 of the guide slot 98, and therefore the tilt angle of the worktable 94 is adjusted.

According to the aforesaid design, the user needs to rotate the knob 108 to let the gear 106 drive the worktable 94 to rotate relative to the saw base 92 along with the positioning plate 96 when wishing to adjust the tilt angle of the worktable 94. For a big angle adjustment of the worktable 94, the user needs to rotate the knob 108 several times. Therefore, it takes much time and effort to adjust the tilt angle of the worktable 94.

### SUMMARY OF THE INVENTION

It is the primary objective of the present invention to provide a band saw, which enables the user to adjust the tilt angle of the worktable conveniently with less effort.

To achieve this objective of the present invention, the band saw provides by the present invention comprises a saw base having an upright support, a worktable supported on the upright support and tiltable relative to the saw base, and an adjustment mechanism for driving the worktable to tilt relative to the saw base. The adjustment mechanism comprises a locating seat fastened to the saw base and provided with a guiding channel, a movable bar which is slidably inserted through the guiding channel of the locating seat and has an end slidably coupled to the worktable, and a driving unit connected to the movable bar for driving the movable bar to move axially.

In a preferred embodiment of the present invention, the movable bar is axially provided at one side thereof with a rack, and the driving unit comprises a gear meshed with the rack of the movable bar for driving the movable bar to move axially, a worm shaft meshed with the gear for rotating the gear, and a hand wheel connected to an end of the worm shaft for rotation by a user.

The upright support of the saw base is provided with an inwardly curved shoulder. The worktable has a bottom wall from which an arched bearing block and a lug having a sliding slot are respectively protruded near a front side and a rear side of the worktable. The arched bearing block of the worktable is pivotably supported on the inwardly curved shoulder such that the worktable is tiltable relative to the saw base. The end of the moveable bar is coupled to the lug of the worktable and slidable in the sliding slot of the lug.

### BRIEF DESCRIPTION OF THE DRAWINGS

FIG. 1 is a front view of a band saw according to the present invention, showing the worktable set in horizontal.

FIG. 2 is another front view of the band saw according to the present invention, showing the worktable set in a tilt angle.

FIG. 3 is a perspective view in an enlarged scale of a part of FIG. 2.

FIG. 4 is an enlarged view of a part of FIG. 3.

FIG. 5 is an exploded view of the worktable tilt angle adjustment mechanism of a band saw according to the prior art.

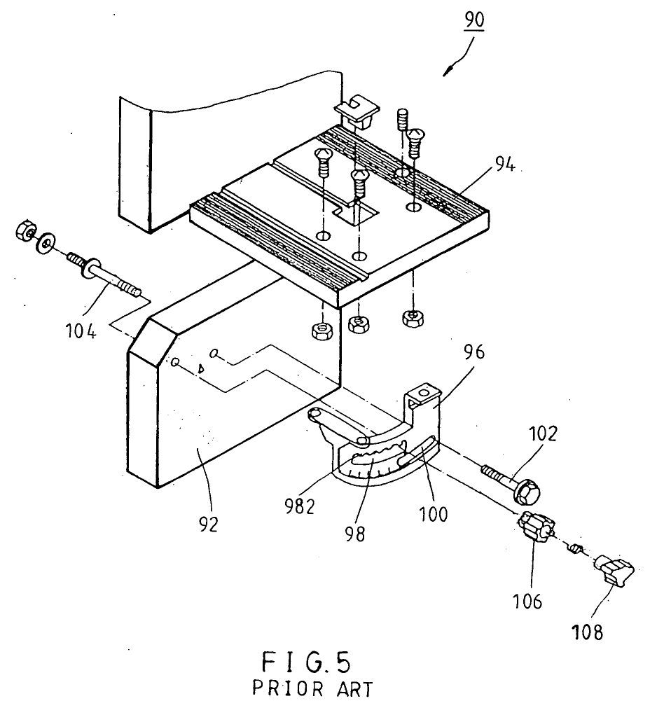

### DETAILED DESCRIPTION OF THE INVENTION

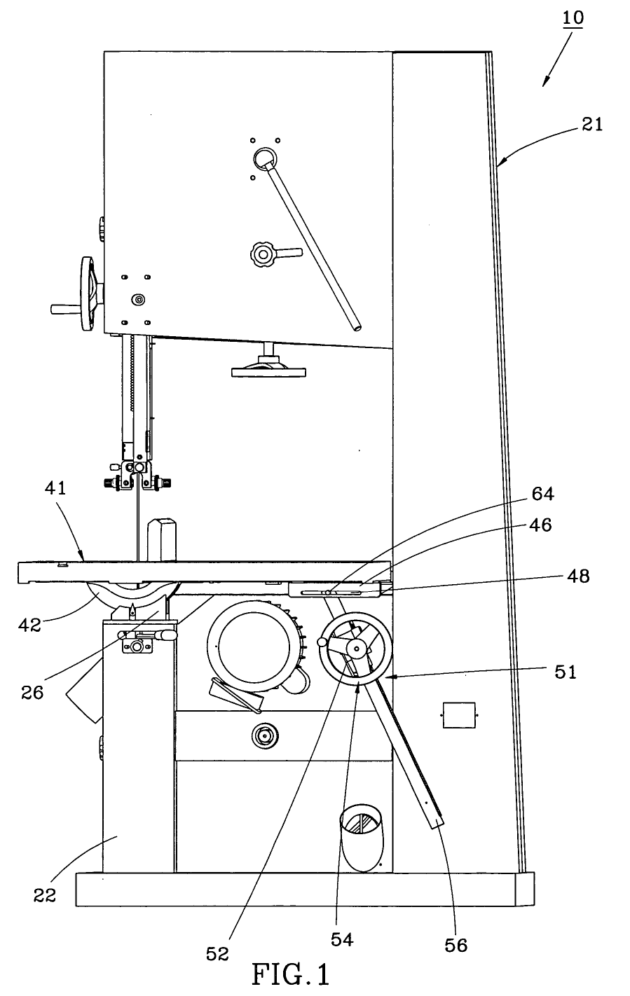

Referring to FIGS. 1-3, a band saw 10 according to a preferred embodiment of the present invention is shown comprised of a saw base 21, a worktable 41, and an adjustment mechanism 51.

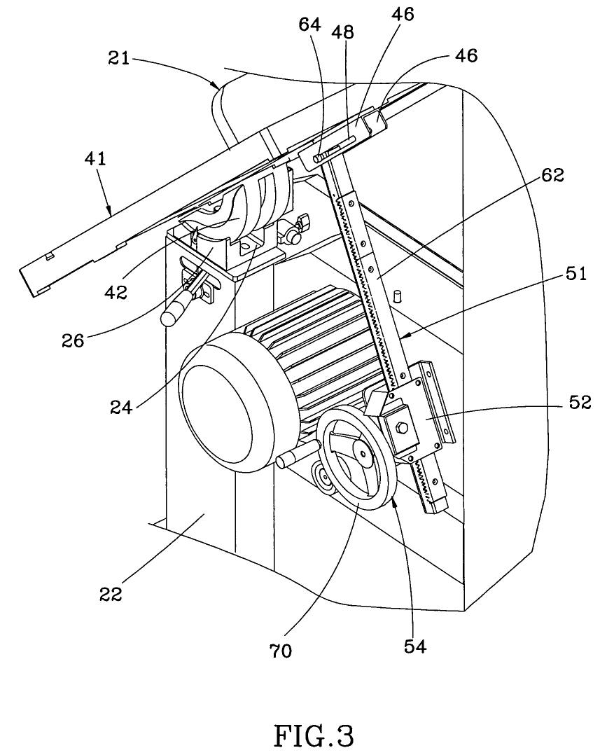

The saw base 21 comprises an upright support 22. The upright support 22 has a top groove 24 and two shoulders 24 spaced above the top groove 24 at two sides. The shoulders 24 each have a top surface curved smoothly inwards, as shown in FIG. 3.

The worktable 41 is adapted to carry the workpiece for cutting, having two arched bearing blocks 42 protruded from the bottom wall near the front side and respectively supported on the shoulders 24, as shown in FIG. 3, and two parallel lugs 46 protruded from the bottom wall near the rear side. The lugs 46 each have a horizontal sliding slot 48. After the arched bearing blocks 42 have been supported on the shoulders 26 of the upright support 22, the user can lift or lower the rear side of the worktable 41 to adjust the tilt angle of the worktable 41 relative to the upright support 22.

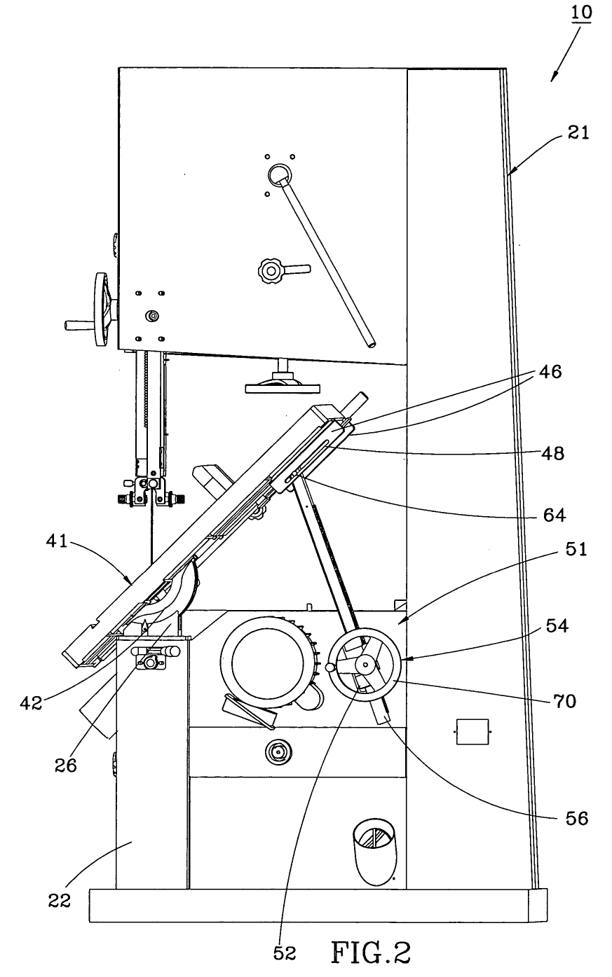

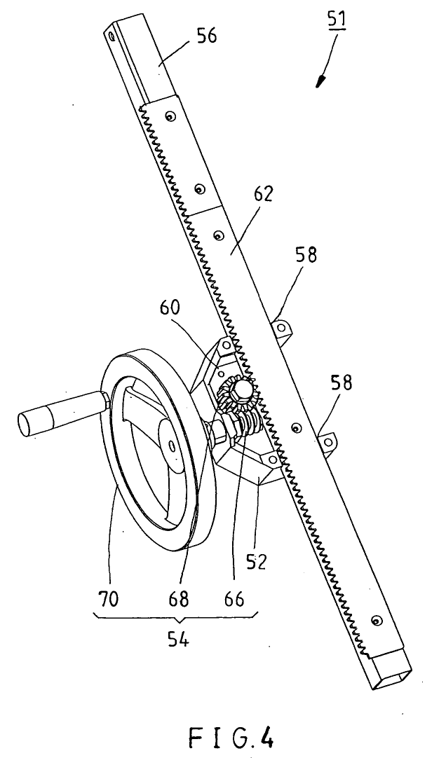

The adjustment mechanism 51 comprises a locating seat 52, a driving unit 54, and a movable bar 56. The locating seat 52 is affixed to the saw base 21 corresponding to one side of the upright support 22, having a guiding channel 58 and a chamber 60 in communication with the guiding channel 58 as shown in FIG. 4. The movable bar 56 is axially slidably mounted in the guiding channel 58 of the locating seat 52, having a rack 62 longitudinally fixedly provided at one side and a top end inserted in between the lugs 46 and movably coupled to the sliding slots 48 of the lugs 46 of the worktable 41 by a pin 64, as shown in FIG. 3. The driving unit 54 comprises a worm shaft 66 and an idle gear 68. The idle gear 68 is rotatably located in the chamber 60 inside the locating seat 52 and meshed with the rack 62. The worm shaft 66 has one end meshed with the idle gear 68 in the chamber 60, as shown in FIG. 4, and the other end fixedly provided with a hand wheel 70. When the user rotates the hand wheel 70, the worm shaft 66 is driven to move the movable bar 56 axially forwards or backwards, thereby causing the movable bar 56 to lift or lower the rear side of the worktable 41 and to further adjust the tilt angle of the worktable 41 in the saw base 21, as shown in FIG. 2.

FIG. 1 shows the worktable 41 set in horizontal. When wishing to adjust the tilt angle of the worktable 41, turn the hand wheel 70 with the hand to rotate the worm shaft 66 and to further move the movable bar 56 axially forwards or backwards, and therefore the worktable 41 is adjusted to the desired tilt angle (see FIG. 2).

As indicated above, the front side of the worktable 41 is supported on the upright support 22, and the movable bar 56 is coupled to the rear side of the worktable 41 through a slip joint. Therefore, by means of the principle of lever, the user can rotate the hand wheel 70 to move the movable bar 56 and to further tilt the worktable 41 to the desired tilt angle.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A band saw comprising:
a saw base having an upright support;
a worktable having a bottom wall, which has a front side pivotally supported on said upright support of said saw base and a rear side, and a pair of lugs fixedly fastened to said bottom wall near said rear side and arranged in parallel, said lugs each having a sliding slot; and
an adjustment mechanism for adjusting a tilt angle of said worktable relative to said upright support, said adjustment mechanism comprising a locating seat fixedly fastened to said saw base, a movable bar slidably inserted through said locating seat, said movable bar having a top end inserted in between said lugs and pivotally coupled to the sliding slots of said lugs, a rack longitudinally fixedly provided at one side of said movable bar, and a worm shaft meshed with said rack for rotation by a user to move said movable bar axially in said locating seat.

2. The band saw as claimed in claim 1, wherein said locating seat comprises a guiding channel, which receives said movable bar for guiding said movable bar to move axially.

3. The band saw as claimed in claim 1, wherein said worm shaft has an end provided with a hand wheel.

4. The band saw as claimed in claim 1, wherein said adjustment mechanism further comprising an idle gear meshed between said rack and said worm shaft.

5. The band saw as claimed in claim 1, wherein said upright support comprises two inwardly smoothly curved shoulders for supporting said worktable; said worktable comprises two arched bearing blocks protruded from said bottom wall near said front side and respectively supported on said inwardly smoothly curved shoulders of said upright support.

6. A band saw comprising:
a saw base having an upright support;
a worktable supported on said upright support and tiltable relative to said saw base;
an adjustment mechanism having a locating seat fixedly fastened to said saw base and provided with a guiding channel, a movable bar slidably inserted through said guiding channel of said locating seat and having an end slidably coupled to said worktable, and a driving unit connected to said movable bar for driving said movable bar to move axially.

7. The band saw as claimed in claim 6, wherein said upright support comprises at least one inwardly curved shoulder and said worktable comprises at least one arched bearing block pivotably supported on said inwardly curved shoulder such that said worktable is tiltable relative to said saw base.

8. The band saw as claimed in claim 7, wherein said arched bearing block is protruded from a bottom wall of said worktable near a front side of said worktable, and the end of said movable bar is slidably coupled to the bottom wall of said worktable near a rear side of said worktable.

9. The band saw as claimed in claim 6, wherein said worktable is provided at a bottom wall thereof with at least one lug that has a sliding slot, and the end of said movable bar is coupled to said lug and slidable in the sliding slot of said lug.

10. The band saw as claimed in claim 6, wherein said movable bar is axially provided at one side thereof with a rack; said driving unit comprises a gear meshed with said rack of said movable bar for driving said movable bar to move axially.

11. The band saw as claimed in claim 10, wherein said driving unit further comprises a worm shaft meshed with said gear for rotating said gear.

12. The band saw as claimed in claim 11, wherein said shaft has an end provided with a hand wheel for rotation by a user.
